(19) United States
(12) Patent Application Publication
(10) Pub. No.: US 2017/0249573 A1
(43) Pub. Date: Aug. 31, 2017

(54) SYSTEM AND METHODS FOR MULTI-PLATFORM PROCUREMENT

(71) Applicant: Steven R. Lively, Sudbury, MA (US)

(72) Inventor: Steven R. Lively, Sudbury, MA (US)

(21) Appl. No.: 15/285,788

(22) Filed: Oct. 5, 2016

Related U.S. Application Data
(63) Continuation of application No. 12/619,667, filed on Nov. 16, 2009, now abandoned.
(60) Provisional application No. 61/115,252, filed on Nov. 17, 2008.

(51) Int. Cl. G06Q 10/06; G06Q 40/00

(52) U.S. Cl. CPC G06Q 10/06313; G06Q 40/12; G06Q 10/06375

(57) ABSTRACT

Systems and methods for providing expanded procurement and/or acquisition of products and/or services. A procurement monitoring system can receive financial data from a vendor of a procurer-vendor relationship and external data associated with establishing a second shared vendor-procurer production facility. The procurement monitoring system can process the received data to determine initiation of a transformation of the procurer-vendor relationship to an expanded procurer-vendor relationship. In certain embodiments of an expanded relationship, the vendor manages and operates both a standard procuring and/or acquisition process for standard contract responsibilities and a shared supplier-procurer procuring and/or acquisition process for expanded contract responsibilities, wherein the shared vendor-procurer procuring and/or acquisition process drives unit and/or service cost reductions and/or secondary materials, components, and/or service cost reductions, a shared or capped arrangement for contract billing for production and/or service deliverables, control of long-term cost from core suppliers, generation of revenue for procuring entity and recoupment of research and development costs from the production of purchased goods, and/or services.

### CROSS-REFERENCE TO RELATED U.S. APPLICATIONS

The present application claims priority to U.S. patent application Ser. No. 12/619,667, filed on Nov. 16, 2009, which claims priority to U.S. provisional patent application No. 61/115,252, filed on Nov. 17, 2008, which is incorporated herein by reference.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### FIELD OF THE INVENTION

The present invention relates generally to systems and methods for procurement of goods and services. In particular, systems and computational algorithms are described which can transform production processes of procured goods and services.

### BACKGROUND

Procurement is the process of selecting for purchase goods and/or services at the best price, in a specified quantity and quality, to be delivered to a designated place or pickup destination on a certain date, and from a selected source for the benefit of or use by the purchaser. Procurement is invoked for the purchase of items that are part of finished products, such as raw material, components and parts, and may also be goods and services for performance as operating resources, such as office supplies, equipment, utilities, land, buildings, and consulting services. Procurement of goods and/or services may be as simple as issuing a purchase order or repeating a purchase, or as complex as issuing a request for proposal (RFP) to one or more competing vendors, specifying a particular good or service to be delivered.

Procurement of goods and/or services is thus a process defined by a series of steps, such as information gathering on vendors, initial request of information from vendors via vendor contact, review of vendors, negotiation of terms of supply, and vendor fulfillment of procured goods and/or services. Referring now to FIG. 3, prior art procurement methods may include a procuring entity performing research and development and procuring products and/or services from a vendor in a non-revenue generating process. Procurement may also include a vendor or supplier delivering product and/or performing service contract responsibilities, creation of prototype products and/or services, delivering of products (products or services out from supplier to procuring entity) and/or services to the procuring entity for profit (money out from procuring entity to supplier), and looking to increase procuring entity costs of such products and/or services.

Similarly, acquisition of new technology, goods, and/or services is a process defined by a series of steps, such as conception, design, engineering, development, testing, demonstration, production, deployment, and support. During acquisition, technology, goods, and/or services are defined and matured into viable concepts, which are subsequently developed and readied for production, wherein later, such technology, goods, and/or services are supported during a support period.

Moreover, a third-party may manage the procurement, acquisition, and/or operations of such production facilities and/or service organizations, wherein procurement of goods and/or services or acquisition of new technology, goods, and/or services occurs. One example of a third-party managed, government organization is the Office of the President at the University of California (UC) managing three Department of Energy (DOE) laboratories, known as Los Alamos National Laboratory, Lawrence Livermore National Laboratory, and Lawrence Berkeley National Laboratory, under UC-DOE Prime Contracts. All DOE labs are federally funded research and development centers that are administered, managed, operated and staffed by private corporations and academic universities under contract to DOE. For the three aforementioned DOE labs, UC manages the operation of the three DOE labs including research, development, procurement of goods, and/or services, acquisition of new technology, goods, and/or services, intellectual property derived from such activities, and licensing of intellectual property for the purpose of advancing science and helping promoting the economic and defensive national interests of the United States of America.

Traditionally, in such third-party managed organizations, supplier production facilities and/or service organizations supplying technology, goods, and/or services are operated and managed by the supplier(s), wherein the supplier(s) controls 100% of the contract billing available from such facilities and/or service organizations and 100% of the production and/or service deliverables by such facilities and/or service organizations without unit cost reduction and/or secondary materials and service costs reduction being offered to the procuring entity.

Therefore, it is readily apparent that there is a need for a dual platform procurement system, process, and method that drives unit and/or service cost reductions and/or secondary materials and/or service cost reductions, and a shared or capped arrangement for contract billing for production and/or service deliverables, in order to control of long-term cost from core suppliers, and generate revenue for procuring entity and recoupment of research and development costs from the production of purchased goods, and/or services.

### SUMMARY

Briefly described, in certain embodiments, the present system and process overcomes the above-mentioned disadvantages, and meets the recognized need for such a system, process, and method by providing a dual platform procurement and/or acquisition process and method of cost reduction, wherein a supplier manages and operates both a standard procuring and/or acquisition process for standard contract responsibilities and a shared supplier-procurer procuring and/or acquisition process for expanded contract responsibilities, wherein the shared supplier-procurer procuring and/or acquisition process drives unit and/or service cost reductions and/or secondary materials, components, and/or service cost reductions, resulting in a shared or capped arrangement for contract billing for production and/or service deliverables, control of long-term cost from core suppliers, generation of revenue for the procuring entity, and recoupment of research and development costs from the production of purchased goods, and/or services.

According to its major aspects and broadly stated, the present solution comprises a dual platform procurement and/or acquisition system, process, and method of cost reduction comprising, in general, the following steps of (a) providing a standard procuring and/or acquisition process for standard unit and/or service contract responsibilities of procurement, (b) creating a shared supplier-procurer procuring and/or acquisition process for expanded unit or service contract responsibilities of procurement to optimize unit and/or service cost reductions.

According to its major aspects and broadly stated, the present invention in an alternate form is a procurement and/or acquisition process and method of cost reduction comprising, in general, the following steps of (a) providing a standard procuring and/or acquisition process for standard unit and/or service contract responsibilities of procurement, (b) creating a shared supplier-procurer procuring and/or acquisition process for standard unit and/or service contract responsibilities of procurement, (c) providing a standard procuring and/or acquisition process for secondary material, component, and/or service contract responsibilities of procurement, (d) creating a shared supplier-procurer procuring and/or acquisition process for expanded material, component, and/or service contract responsibilities of procurement to optimize unit and/or service cost reduction and secondary material, component, and/or service cost reductions.

More specifically, the present invention, in one embodiment, comprises a procurement and/or acquisition process and method of revenue generation comprising the following steps of (a) providing a standard procuring and/or acquisition process for standard contract responsibilities of procurement, (b) providing a shared supplier-procurer procuring and/or acquisition process for expanded contract responsibilities of procurement, and (c) managing said processes via a communication platform having a central server system connected to a database storage device that utilizes a computer program adapted to optimize unit and/or service cost reductions.

Thus, application of the present invention can be designed to transform standard procuring and/or acquisition processes into a dual platform of standard procuring and/or acquisition processing and sharing, further comprising capped arrangement for contract billing for production and/or service deliverables, control of long-term cost from core suppliers, recoupment of research and development costs from the production of purchased goods, and/or service, and generation of revenue through the purchase of lower cost goods and/or services.

Moreover, application of the present system and method is designed to transform throughput manufacturing capacity to generate large purchaser revenue and/or per unit cost reductions, and in specific cases, to generate revenue to recoup costly research and development costs of extremely high cost/high volume/high tech based platforms, including a strategic utilization of the dual platform of standard procuring and/or acquisition process to generate revenue for larger procuring entities.

Accordingly, a feature of the present procurement process with cost reduction is its ability to optimize unit and/or service cost reductions. Moreover, the present procurement process is a system, process and method for optimizing the manufacturing capacity process to generate revenue and/or per unit cost reductions for large purchasers of high volume and high cost product and services and to establish a production model that provides 20% to 40% per unit cost reductions of particular products and services, but also allows for the generation of significant revenue, thereby providing a mechanism to recoup research and development cost of high and extremely high technology products and services.

Another feature of the present procurement process with cost reduction is its ability to optimize unit and/or service cost reduction, secondary material, component, and/or service cost reductions, to generate procurement revenue, and to create domestic manufacturing jobs.

Yet another feature of the present procurement process with cost reduction is its ability to provide a capped arrangement for contract billing for production and/or service deliverables.

Still yet another feature of the present procurement process with cost reduction is its ability to control of long-term cost from core suppliers.

Still yet another feature of the present procurement process with cost reduction is its ability to recoup research and development costs from the production of purchased goods, and/or service.

Still yet another feature of the present procurement process with cost reduction is its ability to create a shared supplier-procurer procuring and/or acquisition process for expanded material, component, and/or service contract responsibilities of procurement.

Still yet another feature of the present procurement process with cost reduction is its ability to enable the procuring entity to generate revenue thru cost reductions when procuring unit, service, material, and/or component.

Still yet another feature of the present procurement process with cost reduction is its ability to provide a domestic economic stimulus opportunity.

Still yet another feature of the present procurement process with cost reduction is its ability to foster addition research and development knowing that the cost of such will be recouped.

Still yet another feature of the present procurement process with cost reduction is its ability to drive down the cost of large or high priced procured items.

Still yet another feature of the present procurement process with cost reduction is its ability to create domestic jobs slowing the outsourcing of domestic employment.

Still yet another feature of the present procurement process with cost reduction is its ability to replenish state of the art and best of breed manufacturing facilities.

Still yet another feature of the present procurement process with cost reduction is its ability to increase the skilled and un-skilled labor force.

Still yet another feature of the present procurement process with cost reduction is its ability to expand the domestic manufacturing base.

Still yet another feature of the present procurement process with cost reduction is its ability to target specific industries to drive down procurement costs.

Still yet another feature of the present procurement process with cost reduction is its ability to target state and regional manufacturing growth.

Still yet another feature of the present procurement process with cost reduction is its ability to revitalize strategic domestic industries.

Still yet another feature of the present procurement process with cost reduction is its ability to establish dual production facilities to maximize production throughput to drive down procured per unit costs.

Still yet another feature of the present procurement process with cost reduction is its ability to turn large procurement expense into a cash generator for procurers of large quantity or high price procured products or services.

Still yet another feature of the present procurement process with cost reduction is its ability to establish dual production facilities to maximize production throughput to drive down procured per unit costs and recoup research and design costs.

Still yet another feature of the present procurement process with cost reduction is its ability to shift operating expenses to a procuring entity, such as cost of land, structure, maintenance, and facility operations.

Still yet another feature of the present procurement process with cost reduction is its ability to create domestic jobs and increase employment tax, number of units delivered, and to revitalize heavy manufacturing.

Still yet another feature of the present procurement process with cost reduction is its ability to be installed and run from any local computer or accessed via the Internet, thus enabling management of the processes via a communication platform having a central server system connected to a database storage device that utilizes a computer program adapted to optimize unit and/or service cost reductions.

Still yet another feature of the present procurement process with cost reduction is its ability to be run on platforms such as, but not limited to, MICROSOFT, SQL, and ORACLE.

These and other features of the procurement process with cost reduction will become more apparent to one skilled in the art from the following Detailed Description of the Preferred and Selected Alternate Embodiments and Claims when read in light of the accompanying drawing Figures.

### BRIEF DESCRIPTION OF THE DRAWINGS

The skilled artisan will understand that the figures, described herein, are for illustration purposes only. It is to be understood that in some instances various aspects of the invention may be shown exaggerated or enlarged to facilitate an understanding of the invention. The drawings are not necessarily to scale, emphasis instead being placed upon illustrating the principles of the teachings. The drawings are not intended to limit the scope of the present teachings in any way.

The present procurement process with cost reduction will be better understood by reading the Detailed Description of the Preferred and Selected Alternate Embodiments with reference to the accompanying drawing figures, in which like reference numerals denote similar structure and refer to like elements throughout, and in which:

FIG. 1 is a block diagram of an embodiment of a computer system which can carry out certain steps of the methods described herein;

FIG. 2 is a block diagram of an embodiment of a communications system within which the computer system in FIG. 1 can be integrated;

FIG. 3.1 is a flow diagram of a prior art process between a procuring entity and a vendor or supplier based on a standard procuring and/or acquisition process for unit and/or primary service and/or delivery of secondary materials, components, and/or performing secondary services;

FIG. 3.2 is a block diagram of a prior art process between a procuring entity and a primary vendor or supplier based on a standard procuring and/or acquisition process for delivery of unit and/or performing primary services;

FIG. 3.3 is a block diagram of a prior art process between a procuring entity and a secondary vendor or supplier based on a standard procuring and/or acquisition process for delivery of secondary materials, components, and/or performing secondary services;

FIG. 4 is a flow diagram of a dual platform procuring and/or acquisition process between a procuring entity and a vendor under a standard and expanded procurement contract for unit and/or primary service and/or delivery of secondary materials, components, and/or performing secondary services, according to the preferred embodiment;

FIG. 5.1 is a block diagram of the process in FIG. 4 between a procuring entity and a primary vendor or supplier based on a standard and expanded procuring and/or acquisition process for delivery of unit and/or performing primary services, according to the preferred embodiment;

FIG. 5.2 is a block diagram of the process in FIG. 4 between a procuring entity and a secondary vendor or supplier based on a standard and expanded procuring and/or acquisition process for delivery of secondary materials, components, and/or performing secondary services, according to the preferred embodiment; and

FIG. 6 is a flow diagram of the steps to implement a dual platform procuring and/or acquisition process between a procuring entity and a vendor under a standard and expanded procurement contract for unit and/or primary service and/or delivery of secondary materials, components, and/or performing secondary services, according to the preferred embodiment.

FIG. 7 represents, in block diagram, an embodiment of a system for monitoring a procurer-vendor relationship and initiating a transformation of the relationship.

FIG. 8 represents a method for monitoring a procurer-vendor relationship and initiating a transformation of the relationship.

The features and advantages of the present invention will become more apparent from the detailed description set forth below when taken in conjunction with the drawings.

### DETAILED DESCRIPTION OF THE EMBODIMENTS

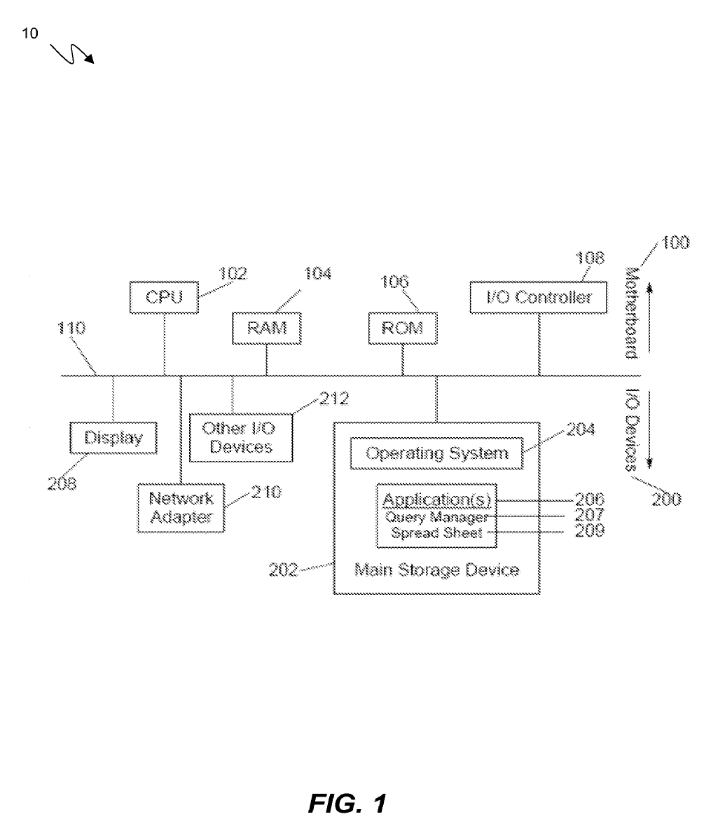

In describing the preferred and selected alternate embodiments of the present invention, as illustrated in FIGS. 1-2, and 4-6, specific terminology is employed for the sake of clarity. The procurement and/or acquisition process and method of cost reduction is not, however, intended to be limited to the specific terminology so selected, and it is to be understood that each specific element includes all technical equivalents that operate in a similar manner to accomplish a similar function.

As will be appreciated by one of ordinary skill in the art, the present invention may be embodied as a method, process, data processing system, or a computer program product. Accordingly, the present invention may take the form of a dual platform of standard and hybrid supplier-procuring entity procurement process, an entirely hardware/firmware embodiment, an entirely software embodiment, or an embodiment combining dual platform, software and hardware aspects. Furthermore, the present invention may take the form of a computer program product on a computer-readable storage medium having computer-readable program code means embodied in the medium. Any suitable computer readable medium may be utilized including hard disks, ROM, RAM, CD-ROMs, electrical, optical or magnetic storage devices.

The present invention is described below with reference to flowchart illustrations of methods, process, apparatus (systems), and computer program products according to embodiments of the present invention. It will be understood that each block or step of such flowchart illustrations, and combinations of blocks or steps in the flowchart illustrations, may be implemented by computer program instructions. These computer program instructions may be loaded onto a general-purpose computer, special-purpose computer, or other programmable data processing apparatus to produce a machine, such that instructions, which execute on the computer or other programmable data processing apparatus, create means for implementing the functions specified in the flowchart block or blocks/step or steps.

These computer program instructions may also be stored in a computer-usable memory that can direct a computer or other programmable data processing apparatus to function in a particular manner, such that the instructions stored in the computer-usable memory produce an article of manufacture including instruction means which implement the function specified in the flowchart block or blocks/step or steps. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks/step or steps.

Accordingly, blocks or steps of the flowchart illustrations support combinations of means for performing the specified functions, combinations of steps for performing the specified functions and program instruction means for performing the specified functions. It should also be understood that each block or step of the flowchart illustrations, and combinations of blocks or steps in the flowchart illustrations, may be implemented by special purpose hardware-based computer systems, which perform the specified functions or steps, or combinations of special purpose hardware and computer instructions.

Computer programming for implementing the present invention may be written in various programming languages, such as, conventional C calling, FORTRAN, Java, Pascal, C+, C++, Visual C, or database languages such as Oracle or .NET. However, it is understood that other source or object oriented programming languages, and other conventional programming language may be utilized without departing from the spirit and intent of the present invention. For brevity, several elements in the figures described below are represented as monolithic entities. However, as will be understood by one ordinarily skilled in the art, these elements each may include numerous connected computers and/or components designed to perform one or more specified operation and/or dedicated to a particular task.

Referring now more particularly to FIG. 1, there is illustrated a block diagram of computer system 10 that provides a suitable environment for implementing embodiments of the present invention. The computer architecture shown in FIG. 1 is divided into two parts, namely, motherboard 100 and input/output (I/O) devices 200. Motherboard 100 preferably includes subsystems such as central processing unit (CPU) 102, random access memory (RAM) 104, input/output (I/O) controller 108, and read-only memory (ROM) 106, also known as firmware, which are operable via bus 110. A basic input output system (BIOS) containing basic routines that may help to transfer information between elements (components) within the subsystems of the computer is preferably stored in ROM 106, or operably disposed in RAM 104. Computer system 10 further preferably includes I/O devices 200, such as main storage device 202 for storing an operating system 204, application program(s) 206, and display 208 for visual output, respectively. Main storage device 202 is preferably connected to CPU 102 through a main storage controller (represented as 108) connected to bus 110. Network adapter 210 allows the computer system to send and receive data through communication devices. One example of a communications device is a modem, including cable and digital subscriber line (DSL), cellular, satellite, or other similar modems. Other examples include a transceiver, a set-top box, a communication card, a satellite dish, an antenna, or any other network adapter capable of transmitting and receiving data over a communications link that is either a wired, optical, or wireless data pathway.

Many other devices or subsystems 212 may be connected in a similar manner, including but not limited to, devices such as microphone, speakers, sound card, keyboard, pointing device (e.g., a mouse), floppy disk, CD-ROM player, DVD player, printer and/or modem each connected via an I/O adapter. Also, although preferred, it is not necessary for all of the devices shown in FIG. 1 to be present to practice the present invention, as discussed below. Furthermore, the devices and subsystems may be interconnected in different configurations from that shown in FIG. 1, or may be based on optical or biological processors or gate arrays, or some combination of these elements that is capable of responding to and executing instructions. The operation of a computer system such as that shown in FIG. 1 is readily known in the art and is not discussed in further detail in this application, so as not to unnecessarily complicate the present discussion.

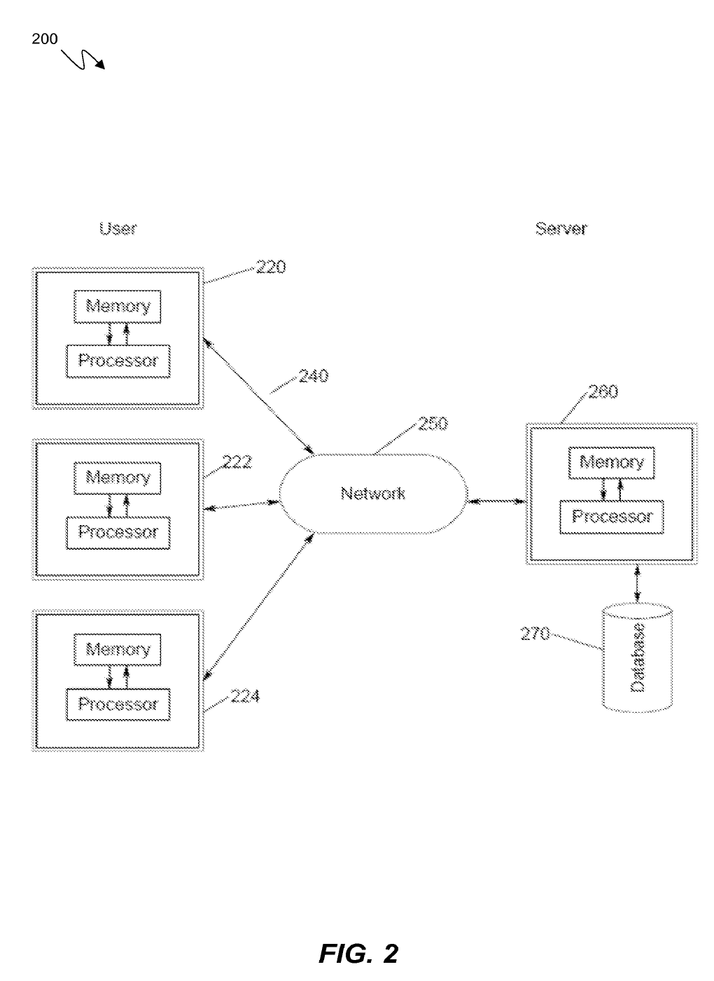

Referring now to FIG. 2, there is illustrated a diagram depicting an exemplary system in which concepts consistent with the present invention may be implemented. Examples of each element within the communication system of FIG. 2 are broadly described above with respect to FIG. 1. In particular, the server system 260 and user system 220 have attributes similar to computer system 10 of FIG. 1 and illustrate one possible implementation thereof. Communication system 200 preferably includes one or more user systems 220, one or more server device 260, and network 250, which could be, for example, the Internet. User systems 220 each preferably include a computer-readable medium, such as random access memory, coupled to a processor. The processor executes program instructions stored in the memory. User system 220 may also include a number of additional external or internal devices, such as, without limitation, a mouse, a CD-ROM, a keyboard, a display, a storage device and other attributes similar to computer system 10 of FIG. 1. Communications system 200 typically includes one or more user system 220. For example, user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a component, other equipment, or some combination of these elements that is capable of responding to and executing instructions.

Similar to user system 220, server system 260 preferably includes a computer-readable medium, such as random access memory (RAM), coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1. Server system 260 may additionally include a secondary storage element, such as database 270 for storage of applications, data and information. Server system 260, although depicted as a single computer system, may be implemented as a network of computer processors. Memory in server system 260 contains one or more application program(s) 206 (shown in FIG. 1). For example, the server system 260 may include one or more general-purpose computers (e.g., personal computers), one or more special purpose computers (e.g., devices specifically programmed to communicate with each other) a workstation or other equipment, or some combination of these elements that is capable of responding to and executing instructions.

Communications system 200 is capable of delivering and exchanging data between user system 220 and a server system 260 through communications link 240 and/or network 250. Through user system 220, users can preferably communicate over network 250 with each other and with other systems and devices coupled to network 250, such as server system 260. Communications link 240 typically includes a delivery network 250 making a direct or indirect communication between the user system 220 and the server system 260, irrespective of physical separation. Examples of a network 250 include the Internet, the World Wide Web, WANs, LANs, analog or digital wired and wireless telephone networks (e.g. PSTN, ISDN, or XDSL), radio, wireless, television, cable, satellite, and/or any other delivery mechanism for carrying and/or transmitting data or other information. The communications link 240 may include, for example, a wired, wireless, cable, optical or satellite communication system or pathway.

Application program 206 (shown in FIG. 1) preferably includes a communication platform enabling secured Internet and video platform. Further, application program 206 enables user 220 and the server 260 to (i) enable communication between supplier, vendor, and procuring entity, (ii) manage standard procuring and/or acquisition process for standard contract responsibilities of procurement and manage shared supplier-procurer procuring and/or acquisition process for expanded contract responsibilities of procurement, and (iii) collect, manipulate, and store procurement information for unit and/or service cost reductions and/or secondary materials, components, and/or service cost reductions, a shared or capped arrangement for contract billing for production and/or service deliverables, control of long-term cost from core suppliers, generation of revenue for procuring entity and recoupment of research and development costs from the production of purchased goods, and/or services.

Application program 206 (shown in FIG. 1) preferably includes query manager 207, which enables server system 260 to communicate with user system 220 to organize and manage querying of main storage device 202 via user system 222 to initiate querying of procurement information, and organize and manage queries of one or more procuring entities, sellers, and vendors.

Application program 206 (shown in FIG. 1) preferably includes spread sheet 209, which enables server system 260 to communicate with user system 220 to organize and manage procurement information of main storage device 202 via user system 222 to initiate calculation and analysis of procurement information, and organize and manage procurement information of one or more procuring entities, sellers, and/or vendors.

Communications system 200 preferably enables users to login, communicate, create working documents, and store working documents using application program 206 via user system 220, user system 222, and server system 260, and to share procurement information between procuring entities, sellers, and vendors as users of user system 220, 222, 224. Further, communications system 200 preferably provides users of user system 220, 222, 224 a registration template with fill-in the blank and user selected criteria for identifying the user and linking procuring entities, sellers, and vendors.

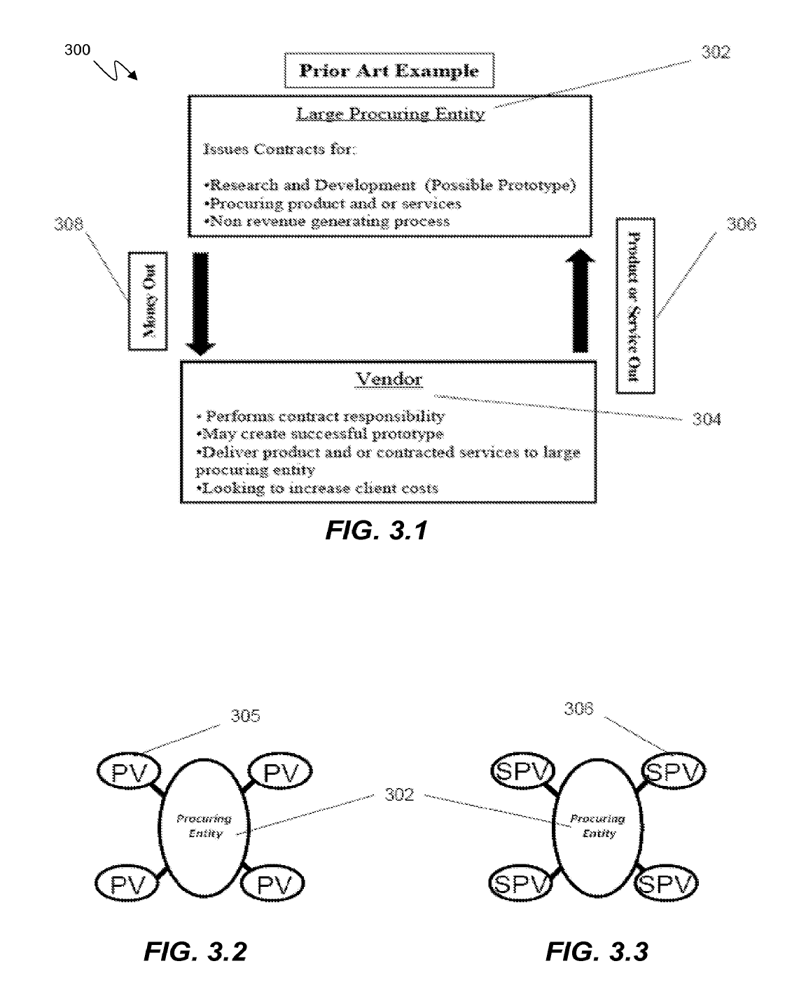

Referring now to FIGS. 3.1-3.3, there is illustrated in FIG. 3.1 a prior art procurement and/or acquisition process 300, between a procuring entity 302 and a vendor or supplier 304 based on a standard procuring and/or acquisition process for unit and/or primary service and/or delivery of secondary materials, components, and/or performing secondary services. Process 300 includes procuring entity 302 performing research and development, and procuring products and/or services from vendor 304 in a non-revenue generating process. Procurement under process 300 may also include a supplier or vendor 304 delivering product and/or performing service contract responsibilities, creation of prototype products and/or services, delivery of products and/or services (product or services out 306 from vendor to procuring entity) to the procuring entity for profit (money out 308 from procuring entity to vendor) and looking to increase procuring entity costs of such products and/or services.

Referring now to FIGS. 3.2 and 3.3 there is illustrated prior art block diagrams of the contracting parties participating in procurement and/or acquisition process 300, including procuring entity 302, primary vendor 305 contracting for delivery of unit and/or performing primary services, and secondary vendor 307 contracting for delivery of secondary materials, components, and/or performing secondary services.

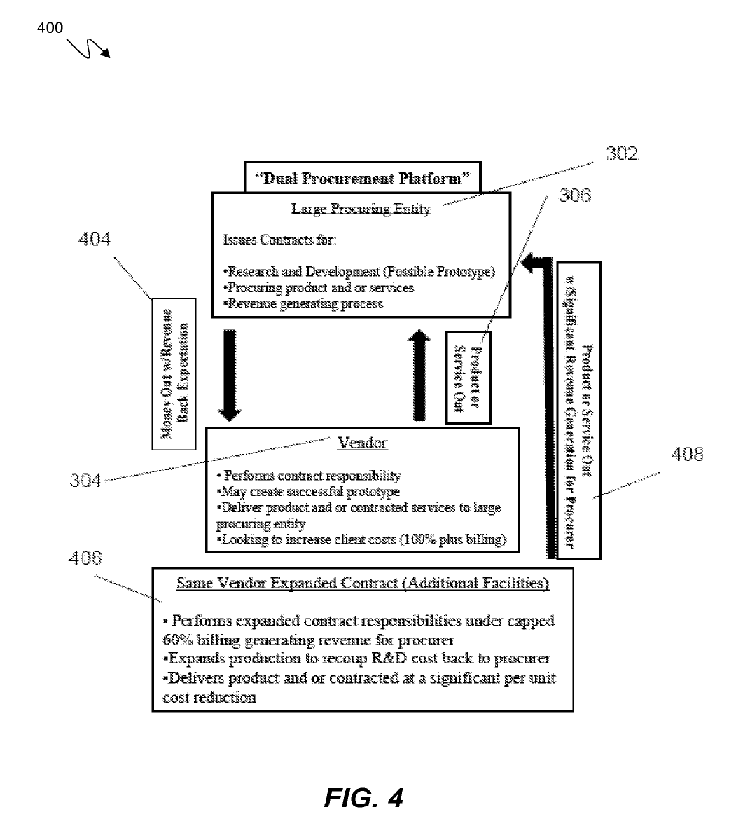

Referring now to FIG. 4, there is illustrated a preferred dual platform procurement and/or acquisition process 400 between a procuring entity and a vendor under a standard and expanded procurement contract for unit and/or primary service and/or delivery of secondary materials, components, and/or performing secondary services. Preferably, process 400 includes procuring entity 302 performing research and development, procuring products and/or services from vendor 304 in a revenue generating process. Procurement under process 400 preferably includes a supplier or vendor 304 delivering product and/or performing service contract responsibilities, creation of prototype products and/or services, delivery of products (product or services out 306 from vendor to procuring entity) and/or services to the procuring entity for profit (money out 308 from procuring entity to vendor) and looking to increase procuring entity costs (100% plus billing) of such products and/or services.

In addition, procurement under process 400 preferably includes a supplier or vendor 304 delivering product and/or performing service contract responsibilities under an expanded procurement contract 406 having capped billing generating revenue for procuring entity 302 due to reduced cost of delivered product and/or performed service, expanded procurement of products and/or services, and delivery of products and/or services (product or services out 408 from vendor to procuring entity under the expanded procurement contract with significant revenue generation for procuring entity 302 expanded contract) to the procuring entity for profit but at reduced cost of delivered product and/or performed service (money out 404 from procuring entity to vendor with the expectation of revenue generation due to reduced cost of delivered product and/or performed service) and looking to decrease procuring entity costs (approximately 20-40% (˜80-60% billing rate)) of such products and/or services. It is contemplated herein that other percentage decreases in procuring entity cost are achievable.

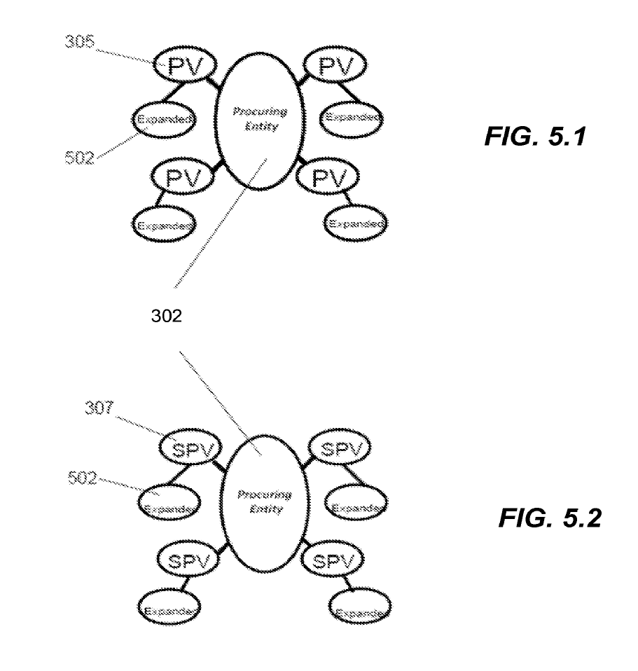

Preferably, expanded procurement contract 406 deliverables of products and/or services are being procured utilizing procuring entity 302 owned facilities, and/or generated from procuring entity 302 owned equipment placed in vendor 304 facilities. Procuring entity 302 invests the capital necessary to build, purchase or lease production facilities, purchase or lease production equipment, purchase or lease real estate, and/or expand services necessary for expanded procurement contract 406 deliverables of products and/or service in exchange for a decrease procuring entity costs (approximately 40% equals revenue generation) of such expanded procurement contract 406 deliverables of products and/or service (expanded facilities and or services 502 shown in FIG. 5). Vendor 304 staffs such expanded facilities 502 with personnel, operates and manages deliverables of products and/or service under expanded procurement contract 406 utilizing its products and/or service know-how and intellectual property in exchange for decreased profit offset by reduced capital outlay required under expanded contract 406 deliverable of products and/or services. Preferably, investments contributed by procuring entity 302 are offset or recouped by purchasing future throughput manufacturing capabilities of expanded facilities 502 at reduced costs and over the length of expanded procurement contract 406, procuring entity 302 and/or vendor 304 can recoup research and development costs through reduced costs and/or by spreading such costs over expanded procurement contract 406 orders for additional products and/or services.

Referring now to FIGS. 5.1 and 5.2, there is illustrated block diagrams of the contracting parties participating in procurement and/or acquisition process 400, including procuring entity 302, primary vendor 305 contracting for delivery of unit and/or performing primary services, and secondary vendor 307 contracting for delivery of secondary materials, components, and/or performing secondary services. Moreover, vendor 304 (whether prime vendor (PV) or sub-prime vendor (SVP)) staffs such expanded facilities 502 with personnel, operates and manages deliverables of products and/or service under expanded procurement contract 406, utilizing its products and/or service know-how and intellectual property. Procuring entity 302 invests the capital required to build, purchase or lease production facilities, purchase or lease production equipment, purchase or lease real estate, and/or expand services necessary for expanded procurement contract 406. Preferably expanded facilities 502 are funded by reduced costs realized.

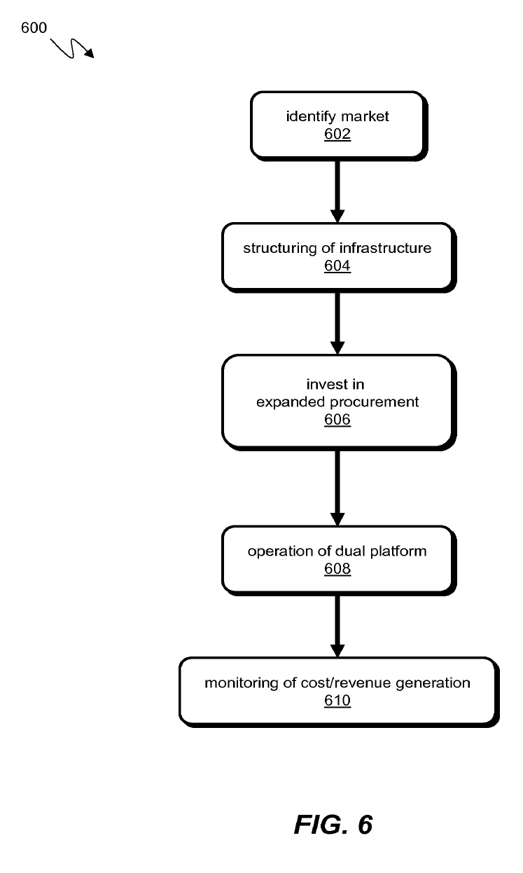

Referring now to FIG. 6, there is illustrated a preferred procurement and/or acquisition process 600 between procuring entity 302 and vendor 304, under a standard and expanded procurement contract 406 for unit and/or primary service and/or delivery of secondary materials, components, and/or performing secondary services. Preferably, process 600 includes steps of identifying market 602, structuring of infrastructure 604, investing in expanded procurement 606, operating of dual platform procurement 608, and monitoring of cost reduction and revenue generation 610.

Preferably, the next step of process 600, identify market 602, occurs when procuring entity 302 and vendor 304 identify the specific industry involved in the procurement and/or acquisition process 600, whether aerospace defense, automotive, agriculture, forestry, electronics, chemicals, telecommunications, pharmaceuticals, publishing/graphic communication, steel, consumer goods, or services and the like. The next identification to occur thereafter is of unit and/or primary service and/or delivery of secondary materials, components, and/or performing secondary services where a decrease in procuring entity costs is desirable, typically high and extremely high technology products and services; however, other less technological products or services may be applicable.

The next step in structuring of infrastructure 604 of process 600 is to identify working group composition procuring entity 302, vendor(s) 304 supplying goods and/or services to procuring entity 302, whether prime vendor (PV) and/or sub-prime vendor (SVP), and any consultants (Working Group) necessary to implement expanded facilities 502 under expanded procurement contract 406. Examples of procuring entity 302 include US Government, Fortune 500 companies, (private industry), large buying groups or associations, small to mid capitalized companies, or small businesses. Preferably, Working Group outlines a schedule for transitioning to expanded facilities 502 under expanded procurement contract 406, including timeline and milestones, identifying goods and services for implementing process 400 and 600, understanding of key technologies and process utilized in delivery of goods and services under procurement and/or acquisition process 600, identifying procured goods and services and large ticket items, key vendor(s) 304 to target, collecting financial and cost data from primary vendor 305 contracting for delivery of unit and/or performing primary services and secondary vendor 307 contracting for delivery of secondary materials, components, and/or performing secondary services, establish criteria for geographical placement of expanded facilities 502, evaluating potential sites for expanded facilities 502, and involve state and federal government in site selection of expanded facilities 502.

For example, key primary vendor 305 contracting for delivery of unit and/or performing primary services and secondary vendor 307 contracting for delivery of secondary materials, components, and/or performing secondary services may include the following:

Department of Defense: Top 20 to 40 Defense and Aerospace production facilities with an objective of providing additional weapons platforms via procurement and/or acquisition process 600, thereby enabling revenue generation due to reduced cost of delivered product and/or performed service and looking to decrease procuring entity costs (approximately 20-40% (˜80-60% billing rate)) of such products and/or services and increased U.S. Military readiness.

Department of Agriculture: Top 20 to 40 Agriculture, Forestry and Chemical production facilities with an objective of driving down cost (Example: dedicated crops for fuel and dedicated crops for food) via procurement and/or acquisition process 600 enabling revenue generation due to reduced cost of delivered product and/or performed service and looking to decrease procuring entity costs (approximately 20-40% (˜80-60% billing rate)) of such products and/or services.

Department of Health and Human Services: Top 20 to 40 Pharmaceuticals production facilities with an objective of driving down cost (Example: major manufacturing increase in the production of generic drugs) via procurement and/or acquisition process 600 enabling revenue generation due to reduced cost of delivered product and/or performed service and looking to decrease procuring entity costs (approximately 20-40% (˜80-60% billing rate)) of such products and/or services.

US Government Printing Office: Strategic Document Corporation production facilities with an objective of driving down cost of graphic communication in produced in the U.S. via procurement and/or acquisition process 600 enabling revenue generation due to reduced cost of delivered product and/or performed service) and looking to decrease procuring entity costs (approximately 20-40% (˜80-60% billing rate)) of such products and/or services.

US Department of the Interior & the Department of Energy: Top 20 Mining, Energy, and Steel companies production facilities with an objective of driving down cost via procurement and/or acquisition process 600 enabling revenue generation due to reduced cost of delivered product and/or performed service) and looking to decrease procuring entity costs (approximately 20-40% (˜80-60% billing rate)) of such products and/or services.

US Department of the Transportation: Top 20 to 40 Automotive production facilities with an objective of driving down cost (Example: major manufacturing increase in the production of fuel efficient vehicles) via procurement and/or acquisition process 600 enabling revenue generation due to reduced cost of delivered product and/or performed service) and looking to decrease procuring entity costs (approximately 20-40% (˜80-60% billing rate)) of such products and/or services.

The next step of the method is to collect financial and cost data form primary vendor 305 contracting for delivery of unit and/or performing primary services and secondary vendor 307 contracting for delivery of secondary materials, components, and/or performing secondary services.

For example, the following Table 1 may be used to collect financial and cost data from vendors 304, vendor Financial Data under standard procurement and/or acquisition process 300 (spread sheet manual or electronic utilizing computer system 10 and/or communication system 200):

TABLE 1
Vendor Financials Data (Prime or Sub Prime)

| Income Statement | Statement of Cash Flows | Balance Sheets |
|---|---|---|
| Total Revenue | Operating: | ASSETS |
| Cost of Sales | Net Income (loss) | CURRENT ASSETS |
| Gross Margin | Adjustment to reconcile | Cash and cash equivalents |
| Gross margin % | net income (loss) | Accounts receivable, net |
| Operating Expense: | for cash provided by | Current assets, other |
| General & Administrative | (use in) oper. activ. | Total Current Assets |
| Sales & Marketing | Depreciation | FIXED ASSETS |
| Total Operating Expense | and amortization | Land |
| Profit/(Loss) from Operations | Changes in operating | Building |
| Total Other Income (Expenses) | assets and liabilities: | Equipment |
| Net Income (Loss) | Accounts receivable | Furniture |
| before taxes | Other current assets | Leasehold improvements |
| | Accounts payable | Purchased software |
| | Accrued expenses | Less accumulated |
| | Commission Payable | depreciation |
| | Other liabilities | and amortization |
| | Net cash provided by (used in) | Total Fixed Assets |
| | operating activities | OTHER ASSETS |
| | Investing activities: | Rent Deposit |
| | Purchase of Furniture | Build out Deposit |
| | Purchase of Land | Equipment deposits |
| | Purchase of Bldg | Total Other Assets |
| | Purchase of Software /Hardware | TOTAL ASSETS |
| | Purchase of Equipment | LIABILITIES |
| | Rent Deposit | CURRENT LIABILITIES |
| | Build out | Accounts payable |
| | Transaction costs | Commissions |
| | Equipment deposits | Payable |
| | Net cash provided by (used in) | Accrued expenses |
| | Investing | Other current |
| | Financing activities: | liabilities |
| | Proceeds from Bank Loan | Total Current Liabilities |
| | Proceeds from Vendor funding | LONG TERM LIABILITIES |
| | Proceeds from (payments | Mortgage Debt |
| | on) capital lease, | Vendor Equipment funding |
| | Proceeds from Mortgage | Long-Term Debt-BONDS |
| | Proceeds from issuance of stock, net | Total Liabilities |
| | Proceeds from issuance of | STOCKHOLDERS' EQUITY |
| | (payments on), debt net | Preferred Stock |
| | Net cash provided by (used in) | Common Stock |
| | financing | Deferred Compensation |
| | Net increase (decrease) in cash | Additional paid-in capital |
| | Cash at beginning of period | Retained earnings (deficit)-prior |
| | Cash at end of period | Net income (loss)-current year |
| | | Total Shareholder's Equity |
| | | TOTAL LIABILITIES |
| | | & STOCKHOLDERS' EQUITY |

Preferably Working Group analyzes Table 1 to determine the cost centers, including materials costs, manufacturing labor costs, number of manufacturing labor employees, production management costs, numbers of production management, production facilities utility costs, total of production facilities insurance costs, manufacturing plant costs, manufacturing production and assembly equipment and supportive technologies costs, understanding of maximum production annual throughput on a particular product, understanding of the annual throughput cost to produce that particular product, and understanding of mark-ups for goods and services delivered under standard procurement and/or acquisition process 300 and transfers such data to Table 2 Financial Model of expanded facilities 502 under expanded procurement contract 406 (spread sheet manual or electronic utilizing computer system 10 and/or communication system 200).

TABLE 2

| | 1 to 1 Production = 60% Contract Billing; Possibly | | |
|---|---|---|---|
| Focus | 1 to 1 “or” 1 to 1.5 R&D = Recoupment | | |
| COS: | Two Level Dual | Mirror of Key Vendor | |
| Research and development costs | Production Focus: | Facilities/Facility: | |
| (Where applicable) | 1). Primary level unit contract | # of Production Management | |
| Materials Cost | production at “key” vendor company | Employees | |
| Sales and or Marketing Cost | 2). Second level; | # of Production Employees | |
| Production Management Cost w/benefits | materials cost reduction level | # of product production facilities | |
| Employee Production Cost w/benefits | (Materials Vendors) | Annual Throughout: | |
| Production Management Cost w/o benefits | Contract Specifications: | Per unit price or revenue | |
| Employee Production Cost w/o benefits | Total of Product Specific R&D Costs | Factor in total of research and | |
| # of Production Management Employees | Total # of contracted units | development costs | |
| # of Production Employees | Contract Life | Calculate time needed to recoup | |
| # of product production facilities | Extend Contract Life to Recoup R&D | research and development costs | |
| Manufacturing and Assembly Plant Costs: | Materials Cost | Calculate research and development | |
| Furnishing | Sales and or Marketing Cost | costs + per unit cost reduction | |
| Building(s) Cost | NEVETS Facilities (1 to 1 | Significant Focus: Capped/ Full | |
| Land Acquisition Costs | Production Facilities | Disclosure | |
| Manufacturing Equipment Costs | Match; Incorporate latest | N/A | |
| Assembly Equipment Costs | technologies): | | |
| Utilities Costs | Manufacturing and Assembly Plant- | | |
| Building Insurance Costs: | Furnishing Costs | 1 to 1 | No Mark-ups |
| Equipment Insurance costs | Building(s) Cost | 1 to 1 | No Mark-ups |
| Liability Insurance costs | Land Acquisition Costs | 1 to 1 | No Mark-ups |
| Other costs- | Manufacturing Equipment Costs | 1 to 1 | No Mark-ups |
| IT Costs | Assembly Equipment Costs | 1 to 1 | No Mark-ups |
| Computer Costs, etc. | Utilities Costs | 1 to 1 | No Mark-ups |
| Annual Throughput: | Equipment Insurance costs | 1 to 1 | No Mark-ups |
| # of contracted units that can be | Liability Insurance costs | 1 to 1 | No Mark-ups |
| produced annually- | Other costs- | 1 to 1 | No Mark-ups |
| Shift1 | IT Costs | 1 to 1 | No Mark-ups |
| Shift2 | Computer Costs, etc. | 1 to 1 | No Mark-ups |

| | | |
|---|---|---|
| Shift 3 | 4 Shifts, End of Overtime- | Eliminates Overtime |
| Shift 4 (if applicable) | Employee Production Cost w/benefits | Eliminates Overtime |
| Costs per unit for the annual contracted | Production Management Cost w/o benefits | Eliminates Overtime |
| contracted number of units | Mirror of Key Vendor Facilities/Facility- | |
| | # of Production Management | |
| | # of Production Employees | |

Next, Working Group determines feasibility of implementing expanded facilities 502 under expanded procurement contract 406 between procuring entity 302 and vendor(s) 304 supplying goods and/or services to procuring entity 302. If feasibility of implementing expanded facilities 502 under expanded procurement contract 406 is cost effective, the method proceeds to the next step.

Next, preferably, in the step structuring of infrastructure 604 of process 600, procuring entity 302 and vendor 304 agree to enter into expanded procurement contract 406 and structure the design, build out, and time line of expanded facilities 502. Preferably, procuring entity 302 and vendor 304 define, configure, design, and develop, expanded facilities 502 in order to deliver expanded goods and services under expanded procurement contract 406.

Preferably procuring entity 302 and vendor 304 finalize plans for expanded facilities 502, such as a manufacturing and assembly infrastructure, including: defining functional requirements, gathering financial information on existing vendor 304 manufacturing and assembly facilities, gathering existing facilities construction blue print drawings from vendor 304, incorporating updated rule and regulation enhancements, such as environmental, construction, energy efficiency into construction plan, incorporating procuring entity 302 enhancements into construction plan, conducting conference room pilot, performing gap analysis, incorporating design enhancement and design interfaces, specifying required technical infrastructure.

In addition, procuring entity 302 and vendor 304 finalize plans for expanded facilities 502, such as a information technology (IT) based on computer system 10 and/or communication system 200, including: defining system functional requirements, configuring process 600 flows to software, configure and customizing software, conduct conference room pilot, performing gap analysis, designing enhancements and interfaces, specifying technical infrastructure for communication system 200, developing transition & data conversion strategies, performing build out test and production software configurations, developing enhancements/interfaces/reports configurations, developing data conversion routines, developing test strategy, developing test scripts and test cycles, conducting functional/integration/volume test cycles, and preparing help desk & support procedures.

Software specification ensues, comprising: design and build interfaces, functional capabilities, performance levels, data structures/elements, safety, reliability, security/privacy, quality, and constraints and limitations.

Software key requirements preferably comprises: template, method for identifying requirements and linking sources, business operation rules, and a traceability matrix.

Software overall description preferably comprises: product perspective, product functions, user classes and characteristics, operating environment, user environment, design/implementation constraints, and assumptions and dependencies.

Software external interface requirements preferably comprise: user interfaces, hardware interfaces, software interfaces, and communication protocols and interfaces.

Software system features preferably comprise: system features, description and priority, action/result, and, functional requirements.

Software nonfunctional requirements preferably comprise: performance requirements, safety requirements, security requirements, software quality attributes, project documentation, and user documentation.

Thereafter, preferably in the next step, participants invest in expanded procurement 606, wherein procuring entity 302 and vendor 304 agrees to enter into expanded procurement contract 406 and invest capital into expanded facilities 502. Preferably, procuring entity 302 invests in (builds) expanded facilities 502 or purchases production equipment for such expanded facilities 502 and places that equipment in vendor 304 production facility (may be some expansion costs) or at some location to be determined by procuring entity 302 or vendor 304 based on procurement and/or acquisition process 400.

Next, procuring entity 302 and vendor 304 agree to perform final testing of expanded facilities 502 operation under expanded procurement contract 406. Preferably, vendor 304 and procuring entity 302 have the following responsibilities: completing technical infrastructure set-up and verification, conducting user acceptance testing, conducting mock conversions and business readiness tests, executing go live, supporting operational ramping & stabilization, system tuning, turnover to support, and plan additional phases.

Next, procuring entity 302 and vendor 304 agree to initiate (go live with) expanded facilities 502 operation under expanded procurement contract 406.

Next, preferably in the step operation of dual platform 608, procuring entity 302 and vendor 304 agree to enter into expanded procurement contract 406 and vendor 304 agrees to manage and operate expanded facilities 502.

Preferably, vendor 304, contracting for delivery of unit and/or performing primary services, has the following responsibilities:

In performing under the expanded procurement contract 406, vendor 304 (1) manages/operates procuring entity 302 owned production facility and or production equipment, assure and maintain through its management systems that products and services meet or exceed deliverable set forth in expanded procurement contract 406, including using an integrated and effective Quality Assurance Program; (2) provides the intellectual leadership and management expertise necessary to manage and operate expanded facilities 502; (3) uses integrated, resource-loaded plans and schedules to achieve expanded procurement contract 406 objectives, incorporating input from the stakeholders; (4) maintains sufficient technical depth to manage activities and projects throughout the life of expanded procurement contract 406; (5) uses appropriate technologies to reduce costs and improve performance; (6) maintains a system of management and business internal controls to assure the safeguarding expanded facilities 502 and procuring entity 302 investments in expanded facilities 502 and other assets; (7) maintains expanded facilities 502 to accomplish assigned missions under expanded procurement contract 406; (8) is responsible for the hiring and training and staffing the expanded facilities 502; (9) covers all employee benefits; (10) employees or independent of vendor 304 operate procuring entity 302 owned expanded facilities 502 and or production equipment; and (12) and supports top line goal of delivering contract cost reduction, material or other product and services.

Moreover, vendor 304 shall manage procuring entity 302 owned expanded facilities 502 and infrastructure, both provided and acquired. Vendor 304 shall use a performance-based approach to real property life-cycle asset management to perform overall integrated planning, acquisition, upgrades, and management of expanded facilities 502 owned, leased or controlled facilities and real property. Vendor 304 shall employ facilities management practices that are best-in-class and integrated with mission assignments and business operations. Vendor 304 maintenance management program shall be based on best practices to maintain procuring entity 302 property in a manner which: (1) promotes and continuously improves operational safety, environmental protection and compliance, property preservation and cost effectiveness, (2) ensures continuity and reliability of operations, fulfillment of program requirements and protection of life and property from potential hazards, and (3) ensures the condition of all assets will continuously improve over the period of performance.

Additional operational and management requirement of vendor 304 can include any combination of the following tasks:

### Business Operations

Vendor 304 shall manage and administer a system of internal controls for all business and administrative operations. Management of the expanded facilities 502 business and administrative operations shall preferably include: (1) integrating common systems of internal controls across the expanded facilities 502 and implementing business processes that are risk-based, cross-functional, cost effective, optimize and streamline operations, increase efficiency and enhance productivity; and, (2) supports in the identification and application of enterprise-wide electronic processes throughout to streamline business practices.

### Human Resources Management

Vendor 304 shall maintain a human resources management system to attract and retain a world class workforce under equal employment opportunity practices. Vendor 304 shall conduct comprehensive pre-employment screening as part of its human resources management system.

### Financial Management

Vendor 304 shall maintain a financial management system that provides sound financial stewardship and public accountability. The overall system shall be suitable to collect, record, and report all financial activities; include a budgeting system for the formulation and execution of all resource requirements; include a disbursements system for employee payroll and supplier payments; and contain an effective internal control system for all expenditures.

### Purchasing Management

Vendor 304 shall maintain an approved purchasing system to provide purchasing support and subcontract administration. Vendor 304 shall, when directed by the procuring entity 302 may, but only when authorized by the procuring entity 302, enter into subcontracts for the performance of any part of the work under expanded procurement contract 406.

### Personal Property Management

Vendor 304 shall have a procuring entity 302 approved management system for overall integrated planning, acquisition, maintenance, operation, control, accountability, utilization, and disposal of procuring entity 302 owned personal property.

### Real Property Management

Vendor 304 shall manage procuring entity 302 owned and leased real property to perform under expanded procurement contract 406. Vendor 304 shall perform overall integrated planning, acquisition, maintenance, operation, management and disposition of procuring entity 302 owned real property, leased facilities, and infrastructure used by the vendor 304 under expanded procurement contract 406. Real property may also be made available to private and public sector entities, including universities, industry, and local, state, and other government agencies, subject to the procuring entity 302 approval. Real property management shall include providing appropriate office space for the procuring entity 302 site office.

### Information Resources Management

Vendor 304 shall maintain the inter-site and intra-site classified and unclassified information, system for technical programs, organizational, business and operations functions and for activities including general purpose programming, data collection, data processing, report generation, software, electronic and telephone communications. Vendor 304 shall provide computer resource capacity and capability sufficient to support (1) facilities-wide information management requirements and (2) facilities wide classified computing infrastructure. Vendor 304 shall maintain a records management program. Vendor 304 shall, with procuring entity 302 approval, standardize non-scientific software and hardware programs/platforms within the facility for generating and storing electronic information.

### Legal Affairs

Vendor 304 shall maintain a legal program to support expanded procurement contract 406 activities including those related to patents, licenses, and other intellectual property rights; subcontracts; technology transfer; environmental compliance and protection; labor relations; and litigation and claims.

### Self-Assessment Program

Vendor 304 shall conduct a self-assessment program that will be used, in part, to assess: (1) the overall performance in facilities operations and administration, (2) delivery of scheduled components and capabilities, and (3) science and technology programs performance. Vendor 304 self-assessment program shall be a key element of the Vendor 304 Assurance System and supports the self assessment report required by procuring entity 302.

### Audits and Assessments

Vendor 304 shall conduct an audit program which provides capabilities for both internal and subcontractor audits and supports external audits, reviews, and appraisals.

### Community Support

Vendor 304 shall, with procuring entity 302 approval, provide community support to facilitate operations, including coordination with the facility. Vendor 304 shall perform a periodic needs assessment to determine what support to the community is necessary to facilitate operations.

### Other Administrative Services

Vendor 304 shall provide other administrative services to include operating communications systems; operating transportation and traffic management services, managing and operating a records management system; and operating a systems of records for individuals including those related to personnel radiation exposure information, medical, safety and health; logistics support to the facility Site Office, when approved by procuring entity 302; and, support other initiatives, when approved by procuring entity 302.

### Training

Vendor 304 shall implement a training and qualification program including general training, orientation, and indoctrination; employee development; educational and professional advancement, and facilities-specific training and qualification. All facilities training and qualification programs shall emphasize the environment, safety and health, and safeguards and security aspects of job and position responsibilities. Vendor 304 training and qualification program shall be an element of expanded facilities 502 integrated safety management process. Vendor 304 shall provide other training programs and opportunities as approved by the procuring entity 302. Vendor 304 shall ensure the continuing involvement by senior management in directing and evaluating the training and qualification program.

### Reports and Other Deliverables

Vendor 304 shall prepare, submit, disseminate, or otherwise publish financial, schedule, scientific, and technical performance plans and reports; and other information and deliverables consistent with the needs of the various programmatic sponsors and other customers or as required elsewhere in expanded procurement contract 406 or as specifically required by the procuring entity 302.

Next, preferably in the step monitoring of cost reduction/revenue generation 610 procuring entity 302 and vendor 304 have access to enter into expanded procurement contract 406 and vendor 304 agrees to manage and operate expanded facilities 502.

Preferably vendor 304 and procuring entity 302 have access to information technology (IT) based on computer system 10 and/or communication system 200 enabling vendor 304 and procuring entity 302 to track cost reduction/revenue generation of goods and services produced by expanded facilities 502 under expanded procurement contract 406.

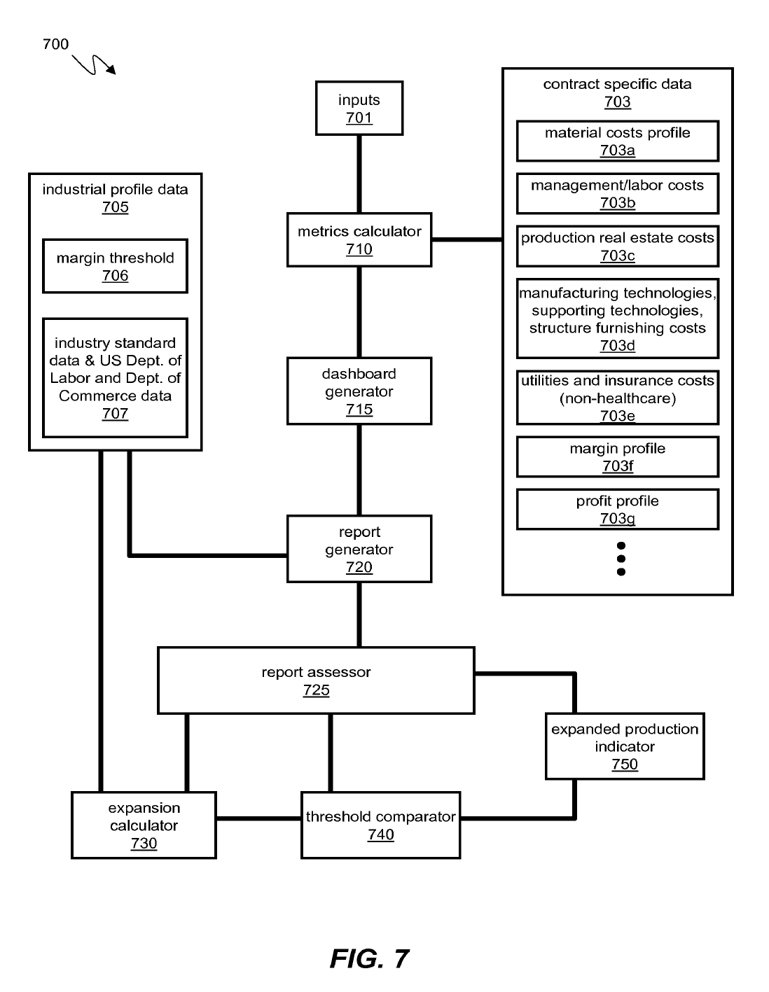

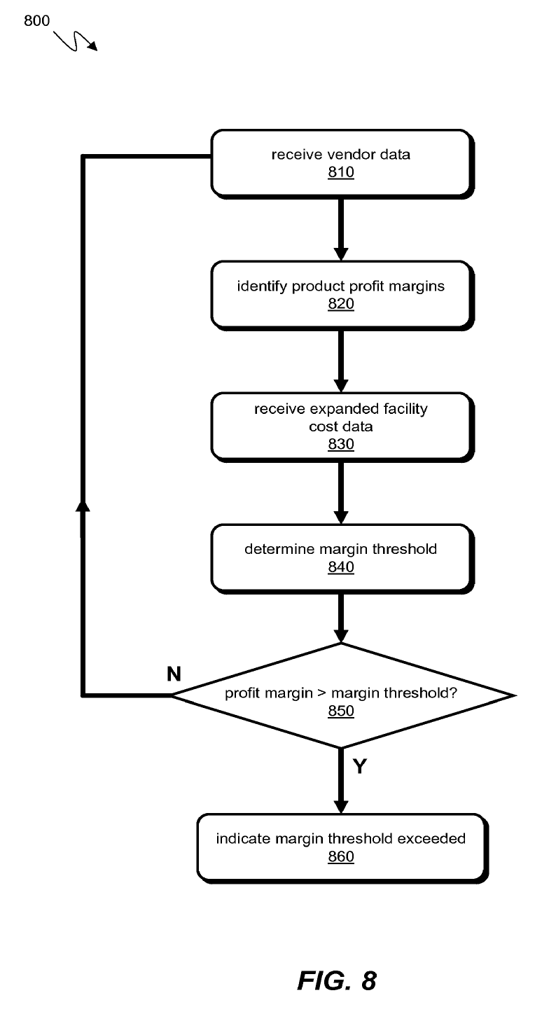

An embodiment of a system 700 for multi-platform procurement is depicted in FIG. 7. In certain embodiments, the system 700 is adapted to execute one or more of the process steps described in reference to FIG. 4, FIG. 6, and/or FIG. 8. The system 700 can comprise hardware, software, machine interpretable instructions executing on a processor, or any combination thereof. In overview, the system 700 comprises a metrics calculator 710, an expansion calculator 730, and an expanded production indicator 750. In certain embodiments, the system 700 further comprises one or more of the following components in any combination: a dashboard generator 715, a report generator 720, a report assessor 725, and a threshold comparator 740. In various embodiments, the system 700 is in operation on a computer or electronic processing instrument operated by, or on the behalf of a procurer 302 who can be in a business relationship with a vendor 305. Although certain components of the system 700 are shown in direct communication with certain other components of the system, in practice any component can be in communication directly, or indirectly, with any other component of the system. Additionally, any one component can be in communication with an external network, e.g., a local area network (LAN), a medium area network (MAN), and/or a wide area network (WAN).

The metrics calculator 710 can receive external inputs 701, e.g., limits, parameters, and definitions, provided by an administrator of the system 700 or provided by another electronic instrument, e.g., a computer or database. The metrics calculator 710 can comprise hardware, software, machine interpretable instructions executing on a processor, or any combination thereof. In various implementations, the metrics calculator 710 is adapted to receive financial data relating to a cost basis of a product of a first vendor facility. As used herein, the term “product” can refer to a composition of matter, a manufactured good, a component of a manufactured good, or a service. The first vendor facility can be in a procurer-vendor relationship with a procurer 302. Data received by the metrics calculator 710 can include contract specific data 703 as depicted in FIG. 7. In operation, the metrics calculator 710 can process received data to generate metrics descriptive of contract performance of the first vendor facility. The metrics calculator 710 can further identify a first profit margin of a product sold to procurer 302 in the procurer-vendor relationship. The profit margin can be determined, by the metrics calculator 710, from provided cost basis data and/or from a profit margin value provided by the vendor. In some embodiments, the contracted price and billed price of a product or service are received by the metrics calculator 710. As an example, the contracted price can be received from inputs 701 and the billed price can be received from contract specific data 703.

Contract specific data 703 received by the metrics calculator 710 can include margin profile data 703f and/or profit profile data 703g. This data can provide information about cost structure for a vended product. As an example, margin profile data 703f and/or profit profile data 703g can include sub-contractor or sub-vendor charges relative to mark-ups, mark-ups for accelerated charges, charges for author's alterations, charges for engineering design changes, charges for accelerated author's alterations or accelerated engineering design changes, project overtime costs, etc.

Output from the metrics calculator 710 can be provided to a dashboard generator 715. The dashboard generator 715 can comprise hardware, software, machine interpretable instructions executing on a processor, or any combination thereof. In various embodiments, the dashboard generator 715 receives data from one or more components of the system 700 and provides the data for display on a video monitor to assist or enable human interfacing with the system 700. In certain embodiments, the dashboard generator 715 produces a graphical user interface which is displayed on a video monitor. The dashboard generator 715 can display any results calculated by one or more components of the system 700. In some embodiments, the dashboard can display any cost accelerators provided to it by one or more system components, e.g., the metrics calculator 710, the report generator 720, the report assessor 725, the expansion calculator 730, identified as one or more of the highest cost drivers for a delivered product or service.

In some embodiments, the system comprises a report generator 720. The report generator 720 can comprise hardware, software, machine interpretable instructions executing on a processor, or any combination thereof. Internal and external data, e.g., vendor performance metrics calculated by the metrics calculator 710 and industrial profile data 705 received from an external source, can be received and processed by the report generator 720. The external data can be received from a data entry source, e.g., a user of the system, or from computing devices networked with the system 700, e.g., government hosted web sites. The report generator 720 can format the received data, compare received data, compute differences between received data, and present results for review and/or further processing. As an example the results generated by the report generator 720 can be provided to the dashboard generator 715 for display. Alternatively, or in addition, the results can be provided to the report assessor 725 and/or expansion calculator 730.

The report assessor 725 can comprise hardware, software, machine interpretable instructions executing on a processor, or any combination thereof. In certain embodiments, the report assessor 725 evaluates received data to determine whether a vendor is receiving excessive profit margins from a procurer 302. The report assessor 725 can additionally determine whether a more favorable price for a vended product can be sustained by the procurer-vendor relationship. In certain embodiments, the report assessor 725 determines whether the procurer-vendor relationship can be transformed to an expanded procurer-vendor relationship, e.g., from relationships depicted in FIGS. 3.2-3.3 to relationships depicted in FIGS. 5.1-5.2. The report assessor 725 can compare contracted and billed prices for a product or service to determine a difference, or delta, between the contracted price and billed price. In some embodiments, the report assessor 725 is combined or integrated with any one or combination of the following system components: the expansion calculator 730, threshold comparator 740, and the expanded production indicator 750.

In various embodiments, the system 700 includes expansion calculator 730. The expansion calculator 730 can comprise hardware, software, machine interpretable instructions executing on a processor, or any combination thereof. The expansion calculator 730 can be adapted to receive data from internal and external sources, e.g., from the report assessor 725 and from an external source or network providing industrial profile data 705. In various embodiments, the expansion calculator 730 receives data identifying costs associated with establishing an expanded production facility to produce the same product. For example, the expansion calculator 730 can receive current pricing of capital equipment, government estimates of current labor costs, estimates of supplies costs, certain operating expenses, etc. The data identifying costs associated with establishing an expanded production facility can include tabulated and/or statistical data compiled by government agencies, municipal agencies, educational institutions, non-profit, or industrial organizations. The expansion calculator 730 can process received data representative of current pricing and estimated costs for establishing an expanded production facility, e.g., a second or additional vendor-procurer facility, and received data from the vendor representative of current financial parameters associated with the product. In some embodiments, the expansion calculator 730 receives data representative of expected or known future demand for the product offered by the vendor. By integrated processing this data, the expansion calculator 730 can determine a margin threshold 706 which identifies a second profit margin at which total profit for the product from the first and second facilities exceeds profit from the first facility when the product is provided at a selected second price which is lower than the first price, i.e., the current trading price offered by the vendor. In some embodiments, the selected second price is between about 90% and 95% of the current trading price, between about 80% and 90% of the current trading price, between about 70% and 80% of the current trading price, between about 60% and 70% of the current trading price, between about 50% and 60% of the current trading price, between about 40% and 50% of the current trading price, and yet in some embodiments between about 30% and 40% of the current trading price. In certain embodiments, the expansion calculator 730 identifies plural margin thresholds, each associated with a different selected second price. The expansion calculator 730 can provide the determined margin threshold 706 to a threshold comparator 740, the report assessor 725, or any other component of the system 700. In some embodiments, the expansion calculator 730 exports the margin threshold 706 to an external network, e.g., to a data store of industrial profile data 705.

In some embodiments, the expansion calculator 730 determines a difference or “delta” between a contracted price and a billed price for a deliverable. The expansion calculator 730 can execute a full financial analysis depending on the value of the delta. For example, if the difference or delta is less than about 5%, then a full analysis may not be needed and would not be executed. If the delta is greater than about 60%, greater than about 50%, greater than about 40%, greater than about 30%, greater than about 20%, greater than about 15%, greater than about 10%, or in some embodiments greater than about 5%, a full financial analysis is run to determine feasibility of transforming to a dual-platform or expanded vendor-procurer relationship. In some instances, the expansion calculator 730 determines a difference or delta between a billed price and industry practices and norms. For example, the expansion calculator 730 can compare a billed price with industrial profile data 705 received to determine whether a billed price is in compliance or significantly out of compliance with industry practices and norms, e.g., a billed price about 5% greater than industry norms, about 10% greater than industry norms, about 15% greater than industry norms, about 20% greater than industry norms, about 30% greater than industry norms, about 40% greater than industry norms, about 50% greater than industry norms, about 75% greater than industry norms, and in some embodiments about 100% greater than industry norms. When the system 700 detects a billed price significantly out of compliance with industry norms, the expanded production indicator 750 can execute tasks associated with transforming the procurer-vendor relationship to an expanded procurer-vendor relationship. In some instances, a margin threshold can be based upon a difference or delta between a contracted price and a billed price, or a billed price and industry practices and norms, or a combination of the two. In certain embodiments, the expansion calculator 730 determines capping prices for certain charges, e.g., materials costs, manufacturing labor costs, production management costs, re-design or alteration costs, etc. The cap prices can be output by the expanded production indicator 750.

The system 700 can further include threshold comparator 740 which can comprise hardware, software, machine interpretable instructions executing on a processor, or any combination thereof. In various embodiments, the threshold comparator 740 compares the margin threshold 706 with the first profit margin to determine whether the first profit margin is greater than the margin threshold value. If the threshold comparator 740 determines that the first profit margin exceeds the threshold margin, the threshold comparator can provide instructions to the expanded production indicator 750 to indicate that the first profit margin is greater than the margin threshold. In some embodiments, the threshold comparator 740 can be incorporated with the expanded production indicator 750.

The expanded production indicator 750 can comprise hardware, software, machine interpretable instructions executing on a processor, or any combination thereof. In various embodiments, the expanded production indicator 750 provides to an administrator of the system 700 an indication when the first profit margin of a product exceeds a calculated margin threshold associated with expanded production by the vendor. In some instances, the expanded production indicator 750 provides instructions to the dashboard generator 715 to produce a visual display indicating that the margin threshold has been exceeded. In some embodiments, the expanded production indicator 750 produces a data file, report, or printed document representative of selected financial calculations executed to determine that the margin threshold has been exceeded. In some embodiments, the expanded production indicator 750 produces documents to aid working groups, as described above, in structuring and validating a second production facility for the vendor. The expanded production indicator 750 can also produce contractual agreement documents containing, for example, product pricing, cost estimates, labor force data, estimated capital outlay expenditures, preferred geographical location, resource and expenditure allocations, etc., which will be used to form a binding contract between the procurer and vendor in the expanded production relationship.

As noted in reference to FIG. 5.1-5.2, an expanded procurer-vendor production relationship can include the formation of a second or addition vendor-procurer facility. The facility can be a limited shared venture between the procurer and vendor. In certain embodiments, the procurer provides certain financial resources for certain outlay costs, e.g., site costs, capital equipment costs, administrative start-up costs, and the vendor operates the facility and provides middle management and labor forces to build and deliver contracted items.

The system 700 can, in some embodiments, facilitate economic growth in a free market economy. The procurement transformation system 700 can rapidly and substantially accurately identify growth opportunities in a procurer-vendor relationship. The system 700 can benefit the procurer 302, by enabling reduced cost of goods, the vendor, by reducing expansion risks and increasing total profits, and the labor force, by timely initiating the creation of new jobs.

In certain embodiments, the system 700 and methods can provide cost savings and/or revenue generation for the procurer as described in the examples below. As an example, a transformation of a vendor-procurer relationship to an expanded vendor-procurer relationship can provide deliverables at reduced cost. The reduced cost can represent a cost savings or revenue generation to the procurer. The cost savings and revenue generation can exist for the life of the second or additional shared vendor-procurer facility. In some embodiments, a set allocation of funds under a contract, e.g. a government contract, may be awarded to a vendor. Upon review of financial data by the system 700, it may be determined that an expanded production facility is feasible. In such a case, the vendor can be asked to return a portion of the awarded funding, which can be used to initiate or operate the additional production facility. The returned funding can constitute a revenue stream for the procurer.

In certain embodiments, the system 700 includes additional subsystems, such as one or more subsystems selected from the following group: supplier and buyer procurement user interaction layer subsystem; purchase capture, release, and maintenance subsystem, receipts subsystem; supplier collaboration engine & network subsystem; strategic sourcing engine subsystem; reporting & audit compliance subsystem; multi tenant, multi platform legacy system interface engine (Ledger, AP, BOM, PIM, EDI . . . ) subsystem; margin policy adherence subsystem; multi-lingual/multi currency subsystem; FAR compliance subsystem; financial management & reconciliation subsystem; security and permissions subsystem; spend analytics subsystem; department level procurement integration subsystem; and NAICS (North American Industry Classification System) code integration subsystem. Any one of these subsystems can be embodied as hardware, software, machine interpretable instructions executing on a processor, or any combination thereof, and be in communication with the system 700. A subsystem can be integrated within the system 700 or operate on a separate processor in communication with the system 700.

An embodiment of a method 800 for monitoring a procurement relationship to initiate a transformation of the procurement relationship is depicted in FIG. 8. The method 800 can be executed by the system 700 as described above. The method 800 can comprise the steps of receiving 810, by a metrics calculator 710, financial data relating to a cost basis of a product of a first vendor facility. The first vendor facility can provide the product to a procurer at a first price, and the procurer and vendor can be in a contract-based procurer-vendor relationship. The method 800 can further include identifying 820, by the metrics calculator, a first profit margin of the product, and receiving 830, by an expansion calculator 730, data identifying costs associated with establishing a second vendor facility to produce the product. The method 800 can further comprise a step of determining 840, by the expansion calculator, a margin threshold based upon the costs associated with establishing the second vendor facility. The margin threshold can identify a second profit margin at which total profit for the product from the first and second proposed facilities exceeds profit from the first facility when the product is provided at a selected second price which is lower than the first price. The method 800 can include a step of comparing 850 the first profit margin with the margin threshold. In various embodiments, the method 800 includes the step of indicating 860, by an expanded production indicator 750, that the first profit margin is greater than the margin threshold.

In certain embodiments, the step of indicating 860 is executed only if the first profit margin exceeds the margin threshold. As noted above in reference to FIG. 7, the margin threshold can depend upon a selected second price for the product. In some embodiments, the method 800 executes automatically and periodically, e.g., every billing cycle. If the first profit margin does not exceed the margin threshold, the method 800 returns to the step of receiving 810 and awaits data input for the next billing cycle.

In some embodiments, the system 700 and method 800 can be managed by a third party distinct from the procurer and vendor. The third party could comprise a government agency or parent company. In some embodiments, the third party can mandate that the vendor and procurer move to an expanded production relationship. It will be appreciated that the system and methods of the present invention can be used for collaborations between any combination of the following organizations: states or state agencies, private industries, federal government or federal agencies, and non-profit organizations. The system 700 and method 800 can provide a cost control tool for procurement of high cost, high volume items, e.g., items listed in the examples described herein. In certain embodiments, the system 700 and method 800 can identify over or excessive charging on particular items or components that make up or are part of a larger deliverable. In some embodiments, the system 700 and method 800 can be used by a procurer to determine when an expanded procurement relationship should be pursued or when a negotiation for better pricing should be pursued.

In some embodiments, certain steps of the method 800 can be performed before certain other steps. As an example, in some embodiments, the step of determining a margin threshold 840 can be executed after the step of receiving 810 vendor data and before the step of identifying 820 margins.

Although the expanded procurement relationship described above in reference to FIGS. 7-8 refers only to a second production facility, the expanded procurement relationship can extend to a third or more production facilities.

In certain embodiments, the system 700 and method 800 further includes contract toggling. For example, after an expanded procurement relationship is established, the system 700 can be used to monitor procurement relationships for each production facility. If excess profit margins are detected at one facility, the expansion calculator 730 determines and reports a production quantity that can be shifted from one production facility to a second production facility. The toggling of production quantity, or ordered products or services, can be used as a leverage to maintain original contract pricing. In some embodiments, the system 700 can automatically toggle ordered quantities from one facility to the other, e.g., increase or reduce quantities ordered for the next or a subsequent billing cycle. For example, the expansion calculator 730 or report assessor 725 can calculate a quantity of deliverables to be diverted from one facility to a second facility and provide the quantity to a computerized purchasing system which will augment quantities ordered for the next or a subsequent order for each vendor facility. In certain embodiments, the system 700 can interface with a purchase-and-order system which is used to issue purchase orders to the vendor.

Further description of the system and methods are provided in Appendix A.

### EXAMPLES

Several examples of implementing the inventive systems and methods are described below. In some embodiments, department of defense (DoD) projects may realize the impacts described in the following examples utilizing processes 400, 600, and/or 800:

### Example 1

### B-2 Stealth Bomber—Reported Cost $2.2 Billion Each

For the cost of one or two B-2 Stealth Bombers, procuring entity 302 (US Government) could build one or two B-2 Stealth Bombers (or replacement) expanded facilities 502 for the production of additional units of B-2 Stealth Bombers saving 20% to 40% per unit utilizing expanded facilities 502 and gaining the total annual production throughput of such expanded facilities 502 under expanded procurement contract 406. (Throughput is the total number of units that can be produced annually.) Moreover, vendor 304 (whether prime vendor (PV) and sub-prime vendor (SVP)) benefit from a longer business relationship under expanded procurement contract 406, providing for additional units to spread research and development cost over, and less initial capital outlay. US Military readiness is increased providing our war fighters with the best in equipment capabilities at a reduced unit cost enabling the US Government to purchase additional units of B-2 Stealth Bombers utilizing the same initial budget. Staffing of expanded facilities 502 will preferably create tens of thousands of new US jobs in targeted geographical areas. Revenue generation on a per unit basis for each B-2 Stealth Bombers utilizing expanded facilities 502 is approximately $444,000,000 to $888,000,000, wherein procuring entity 302 initial investment in expanded facilities 502 is recaptured in short order.

### Example 2

### F-22 Raptor Strike Fighter—Reported Cost $187.3 Million Each

For the cost of one or two F-22 Raptor Strike Fighters, procuring entity 302 (US Government) could build one or two F-22 Raptor Strike Fighters (or replacement) expanded facilities 502 for the production of additional units of F-22 Raptor Strike Fighters, saving 20% to 40% per unit utilizing expanded facilities 502 and gaining the total annual production throughput of such expanded facilities 502 under expanded procurement contract 406. Moreover, vendor 304 (whether prime vendor (PV) and sub-prime vendor (SVP)) benefit from a longer business relationship under expanded procurement contract 406, providing for additional units to spread research and development cost over, and less initial capital outlay. US Military readiness is increased, providing our war fighters with the best in equipment capabilities at a reduced unit cost, enabling the US Government to purchase additional units of F-22 Raptor Strike Fighters utilizing the same initial budget. Staffing of expanded facilities 502 will preferably create tens of thousands of new US jobs in targeted geographical areas. Revenue generation on a per unit basis for each F-22 Raptor Strike Fighters utilizing expanded facilities 502 is approximately $37,460,000 to $74,920,000, wherein procuring entity 302 initial investment in expanded facilities 502 is recaptured in short order.

### Example 3

### Nimitz-Class Supercarrrier—Reported Cost $4.5 Billion Each

For the cost of one or two Nimitz-class Supercarrrier, procuring entity 302 (US Government) could build one or two Nimitz-class Supercarrrier (or replacement) expanded facilities 502 for the production of additional units of Nimitz-class Supercarrrier saving 20% to 40% per unit utilizing expanded facilities 502 and gaining the total annual production throughput of such expanded facilities 502 under expanded procurement contract 406. Moreover, vendor 304 (whether prime vendor (PV) and sub-prime vendor (SVP) benefit from a longer business relationship under expanded procurement contract 406, providing for additional units to spread research and development cost over, and less initial capital outlay. US Military readiness is increased providing our war fighters with the best in equipment capabilities at a reduced unit cost enabling the US Government to purchase additional units of Nimitz-class Supercarrrier utilizing the same initial budget. Staffing of expanded facilities 502 will preferably create tens of thousands of new US jobs in targeted geographical areas. Revenue generation on a per unit basis for each Nimitz-class Supercarrriers utilizing expanded facilities 502 is approximately $900,000,000 to $1,800,000,000, wherein procuring entity 302 initial investment in expanded facilities 502 is recaptured in short order.

### Example 4

### Ballistic Missile Submarine Ohio Class—Reported Cost $700 Million Each

For the cost of one or two Ballistic Missile Submarine Ohio Class, procuring entity 302 (US Government) could build one or two Ballistic Missile Submarine Ohio Class (or replacement) expanded facilities 502 for the production of additional units of Ballistic Missile Submarine Ohio Class saving 20% to 40% per unit utilizing expanded facilities 502 and gaining the total annual production throughput of such expanded facilities 502 under expanded procurement contract 406. Moreover, vendor 304 (whether prime vendor (PV) and sub-prime vendor (SVP) benefit from a longer business relationship under expanded procurement contract 406, providing for additional units to spread research and development cost over, and less initial capital outlay. US Military readiness is increased providing our war fighters with the best in equipment capabilities at a reduced unit cost enabling the US Government to purchase additional units of Ballistic Missile Submarine Ohio Class utilizing the same initial budget. Staffing of expanded facilities 502 will preferably create tens of thousands of new US jobs in targeted geographical areas. Revenue generation on a per unit basis for each Ballistic Missile Submarine Ohio Class utilizing expanded facilities 502 is approximately $140,000,000 to $280,000,000, wherein procuring entity 302 initial investment in expanded facilities 502 is recaptured in short order.

### Example 5

### Print Production Facility

For example, utilizing processes 400, 600, and/or 800, graphic communication projects could have the following impacts:

### Scenarios: (Seven to Ten Years Printing Equipment Shelf life)

#1—Spend $35.4 million on print production equipment as an initial investment in expanded facilities 502 under expanded procurement contract 406 and generate revenue of $20 million per year for the life of the expanded facilities 502 equipment.

#2—Spend $44.4 million on print production equipment as an initial investment in expanded facilities 502 under expanded procurement contract 406 and generate revenue of $26 million per year for the life of the expanded facilities 502 equipment.

#3—Spend $61.8 million on print production equipment as an initial investment in expanded facilities 502 under expanded procurement contract 406 and generate revenue of $40 million per year for the life of the expanded facilities 502 equipment.

#4—Spend $70.8 million on print production equipment as an initial investment in expanded facilities 502 under expanded procurement contract 406 and generate revenue of $44 million per year for the life of the expanded facilities 502 equipment.

#5—Spend $141.6 million on print production equipment as an initial investment in expanded facilities 502 under expanded procurement contract 406 and generate revenue of $98 million per year for the life of the expanded facilities 502 equipment.

Additional examples of beneficiary procuring entities 302 utilizing procurement and/or acquisition process 400, 600, and/or 800 are summarized below.

### Example 6

### Auto Manufacturing

GM preferably could drive down the cost of procured items from secondary vendor 307 contracting for delivery of secondary materials, components, and/or performing secondary services utilized to build their automobiles, such as car seats, bumpers, etc; thus, reducing the overall cost to produce their automobiles.

### Example 7

### Aircraft/Defense Procurer-Vendor Relationship

Lockheed-Martin preferably could drive down the cost of procured items from secondary vendor 307 contracting for delivery of secondary materials, components, and/or performing secondary services utilized to build their systems, such as motors, tires, steel, electronics, ammunition, etc; thus, reducing the overall cost to produce their defense systems.

Lockheed-Martin—reduce per unit cost of procured weapons platforms by 20% to 40%. Option of procuring more systems cheaper or take back the cash (recapture dollars)! U.S. Department of Defense preferably could drive down the cost of procured items from primary vendor 305 contracting for delivery of unit and/or performing primary services utilized to build defense systems, such as aircraft, ships, submarines, etc; thus, reducing the per unit cost of procured weapons platforms by 20% to 40%.

By way of further examples, process 400, 600, and/or 800 procurement cost savings are preferably set forth in two examples Table 3 a printing procurement operation and Table 4 a widget procurement manufacturing and assembly facility.

### Example 8

### Printing Facility

In Table 3 procuring entities 302 and vendor 304 have agreed to invest in expanded procurement 606 and such procuring entities 302 sponsored printing facility has the following summary balance sheet similar to its projected analysis in Table 1 and Table 2.

### Contract Award Example: $54,000,000

TABLE 3

| | Standard Procurement | | Process 400 & 600 | |
|---|---|---|---|---|
| Scanned cost centers | | | | |
| Paper cost | 36,000,000 | | 21,600,000 | Capped |
| Ink Cost | 6,300,000 | | 3,780,000 | Capped |
| Authors' Changes | 2,400,000 | Uncapped | 2,400,000 | Capped |
| Utilities | 2,250,000 | | 1,350,000 | Capped |
| Labor | 7,200,000 | | 4,320,000 | Capped |
| Production Supplies | 900,000 | | 540,000 | Capped |
| Total | 55,050,000 | | 33,990,000 | |
| Revenue | | | 21,060,000 | 38% |
| Generation/Savings | | | 20,000,000 | |

Recouped in first year
via savings

Table 3 discloses a total volume throughput of $55,050,000 under standard procurement column and utilizing process 400, 600, and/or 800 to provide an expanded production facility (printing facility) 502 wherein per unit cost reductions result from capped vendor 304 charges utilized from procuring entities 302 supplying for example real estate, facility, building, and equipment (such as “2” Sheetfed Press and “2” Web Press total Coldset) for the additional throughput facility 502. Preferably, total volume throughput of approximately $33,990,000 under process 400, 600, and/or 800 column, saving procuring entities 302 approximately $21,060,0000 per year for the life of equipment, 7 to 15 years in expanded production facility (printing facility) 502. In addition, procuring entities 302 will not be subject to overtime costs, additional Author's charges for alterations, and/or quick turn charge at its expanded production facility (printing facility) 502. Author's charges for alterations, overtime costs and quick turns may add as much as 50% to 100% increase in procurement cost.

### Example 9

### Part Manufacturing Facility

In Table 4 procuring entities 302 and vendor 304 have agreed to invest in expanded procurement 606 and such procuring entities 302 sponsored widget manufacturing facility has the following summary balance sheet similar to its projected analysis in Table 1 and Table 2.

TABLE 4
Widgets 1,000,000

| | Annual | | Annual | | | |
|---|---|---|---|---|---|---|
| | Cost | Annual | Cost | Annual | Annual | |
| | Raw | Cost | Real | Cost | Cost | |
| | Materials | Labor | Property | Building | Equipment | Total |
| Per unit | $2 | $4 | $2 | $1 | $1 | |
| Cost | | | | | | |
| Standard | $2,000,000 | $4,000,000 | $2,000,000 | $1,000,000 | $1,000,000 | $10,000,000 |
| Procurement | | | | | | |
| 100% | | | | | | |
| Process | $2,000,000 | $4,000,000 | $0 | $0 | $0 | $6,000,000 |
| 400 & | | | | | | 40% |
| 600 | | | | | | savings |
| 60% | | | | | | |

Table 4 discloses a total volume throughput of $10,000,000 under standard procurement row and utilizing process 400, 600, and/or 800 to provide an expanded production facility (widget manufacturing facility) 502 wherein per unit cost reductions result from capped vendor 304 charges utilized from procuring entities 302 supplying for example real estate, facility, building, and equipment (such as an additional manufacturing and assembly plant) for the additional throughput facility 502. Preferably, total volume throughput of approximately $6,000,000 under process 400, 600, and/or 800, saving procuring entities 302 approximately $4,000,000 per year for the life of equipment, 7 to 15 years in expanded production facility (manufacturing and assembly plant) 502.

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

The section headings used herein are for organizational purposes only and are not to be construed as limiting the subject matter described in any way.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A dual platform procurement system providing standard and hybrid procurement methods comprising:
receiving, by a metrics calculator executing on one or more processors, financial data relating to cost basis of a product of a first vendor facility, the first vendor facility providing the product to a procurer at a first price;
identifying, by the metrics calculator executing on one or more processors, a first profit margin of the product;
receiving, by an expansion calculator executing on one or more processors, data identifying costs associated with establishing an expanded production facility to produce the product;
determining, by the expansion calculator executing on one or more processors, a margin threshold based upon the costs associated with establishing the expanded production facility, the margin threshold identifying a second profit margin at which total profit for the product from the first vendor facility and expanded production facility together exceeds profit from the first vendor facility when the product is provided at a selected second price which is lower than the first price; and
indicating, by an expanded production indicator, that the first profit margin is greater than the margin threshold.

2. The method of claim 1, wherein the procurer and first vendor facility execute contractual procurer-vendor obligations.

3. The method of claim 1, wherein the step of identifying comprises receiving the first profit margin value from the vendor.

4. The method of claim 1, wherein the step of identifying comprises calculating, by the metrics calculator, the first profit margin value from the received financial data.

5. The method of claim 1, wherein the step of determining further comprises comparing, by a threshold comparator, the first profit margin to the margin threshold.

6. The method of claim 1, wherein a portion of the costs associated with establishing the expanded production facility are derived from data tabulated or compiled by government, municipal, educational, non-profit, or industrial organizations.

7. The method of claim 1, wherein the selected second price of the product is in a range selected from the following group: between about 90% and 95% of a current trading price of the product, between about 80% and 90% of the current trading price, between about 70% and 80% of the current trading price, between about 60% and 70% of the current trading price, between about 50% and 60% of the current trading price, between about 40% and 50% of the current trading price, and between about 30% and 40% of the current trading price.

8. The method of claim 1, wherein the expanded production facility comprises a shared vendor-procurer facility.

9. The method of claim 1 further comprising generating, by the expanded production indicator, contractual documents for an expanded procurer-vendor relationship.

10. The method of claim 1 further comprising transforming the procurer-vendor relationship to an expanded procurer-vendor relationship.

11. The method of claim 1 further comprising toggling a production quantity from the first vendor facility to the expanded production facility or toggling a production quantity from the expanded production facility to the first vendor facility.

12. A dual platform system providing standard and hybrid procurement methods, the system comprising:
a metrics calculator executing on one or more processors receiving financial data relating to cost basis of a product of a first vendor facility, the first vendor facility providing the product to a procurer at a first price, the metrics calculator further identifying a first profit margin of the product;
an expansion calculator executing on one or more processors determining a margin threshold based upon costs associated with establishing an expanded production facility to produce the product, the margin threshold identifying a second profit margin at which total profit for the product from the first vendor facility and the expanded production facility together exceeds profit from the first vendor facility when the product is provided at a selected second price which is lower than the first price; and
an expanded production indicator indicating that the first profit margin is greater than the margin threshold.

13. The system of claim 12, wherein the procurer and first vendor facility execute contractual procurer-vendor obligations.

14. The system of claim 12, wherein the metrics calculator receives the first profit margin value from the vendor.

15. The system of claim 12, wherein the metrics calculator calculates the first profit margin value from the received financial data.

16. The system of claim 12, wherein the threshold comparator compares the first profit margin to the margin threshold.

17. The system of claim 12, wherein a portion of the costs associated with establishing the expanded production facility are derived from data tabulated or compiled by government, municipal, educational, non-profit, or industrial organizations.

18. The system of claim 12, wherein the selected second price of the product is in a range selected from the following group: between about 90% and 95% of a current trading price of the product, between about 80% and 90% of the current trading price, between about 70% and 80% of the current trading price, between about 60% and 70% of the current trading price, between about 50% and 60% of the current trading price, between about 40% and 50% of the current trading price, and between about 30% and 40% of the current trading price.

19. The system of claim 12, wherein the expanded production facility comprises a shared vendor-procurer facility.

20. The system of claim 12, wherein the expanded production indicator generates contractual documents for an expanded procurer-vendor relationship.

21. The system of claim 12, wherein the expanded production indicator initiates the transforming of the procurer-vendor relationship to an expanded procurer-vendor relationship.
